(19) United States
(12) Patent Application Publication
(10) Pub. No.: US 2026/0175915 A1
(43) Pub. Date: Jun. 25, 2026

(54) VEHICLE

(71) Applicant: KAWASAKI MOTORS, LTD., Hyogo (JP)

(72) Inventor: Yusuke NAKASHIMA, Hyogo (JP)

(73) Assignee: KAWASAKI MOTORS, LTD., Hyogo (JP)

(21) Appl. No.: 19/412,975

(22) Filed: Dec. 9, 2025

(30) Foreign Application Priority Data
Dec. 24, 2024 (JP) 2024-227004

(51) Int. Cl. B62D 21/02; B60D 1/48; B60R 5/04

(52) U.S. Cl. CPC B62D 21/02; B60D 1/488; B60R 5/04

(57) ABSTRACT

A vehicle includes: in a front part of the vehicle in the front-rear direction, a pair of support frames that are arranged apart from each other in the vehicle width direction and to which upper ends of left and right shock absorbers of a front suspension are respectively fixed; a pair of front frames that extend downward from the support frames, respectively; and a front cross member that is bridged between the front frames below the support frames.

### CROSS REFERENCE TO RELATED APPLICATIONS

The present application claims priority to Japanese patent application no. 2024-227004 filed on Dec. 24, 2024, the contents of which are hereby fully incorporated herein by reference.

### TECHNICAL FIELD

The present disclosure relates to a vehicle.

### BACKGROUND

U.S. Patent Application Publication No. 2007/0267837 discloses a golf cart having a frame structure that supports a front suspension system.

### SUMMARY OF THE INVENTION

According to a first aspect of the present disclosure, a vehicle is provided. The vehicle has a pair of support frames, a pair of front frames and a front cross member. The pair of support frames are arranged apart from each other in the vehicle width direction, and upper ends of left and right shock absorbers disposed on a front wheel side of the vehicle are respectively fixed to the support frames. The pair of front frames extend downward from the support frames, respectively. The front cross member is bridged between the front frames.

According to a second aspect of the present disclosure, a vehicle is provided. The vehicle has a first frame, a second frame, a first support part and a second support part. The first frame extends in the vehicle width direction in a front part of the vehicle in a front-rear direction. The second frame extends in the vehicle width direction above the first frame. The first support part is configured to protrude rearward and upward from the first frame. The first support part has a first front end part that is connected to the first frame, and a first rear end part on a side opposite to the first front end part in an extending direction. The second support part is configured to protrude rearward from the second frame. The second support part has a second front end part that is connected to the second frame, and a second rear end part that is connected to the first rear end part. The first support part has a holding part that holds a steering shaft.

According to a third aspect of the present disclosure, a vehicle is provided. The vehicle has a front seat having a seat part that extends in the vehicle width direction, a support part and a detachable frame. The support part includes a pair of side members extending in a front-rear direction of the vehicle, and a support cross member bridged between the side members under the front seat. The detachable frame is removably mounted on the support part. The detachable frame has a lower end part that is connected to the support part and an upper end part that is configured to support the seat part. The detachable frame is configured to define a storage area that has an opening under the seat part when mounted on the support part.

According to a fourth aspect of the present disclosure, a vehicle is provided. The vehicle has a hitch receiver and a rear storage. The hitch receiver extends in the front-rear direction in a rear part of the vehicle. The rear storage has a bottom part that is supported by an upper end part of the hitch receiver.

### BRIEF DESCRIPTION OF THE DRAWINGS

FIG. 1 is a schematic side view of a vehicle according to one embodiment of the present disclosure.

FIG. 2 is a schematic perspective view of a body frame.

FIG. 3 is a schematic top view of the body frame.

FIG. 4 is a schematic front view of the body frame on which a front suspension and a front storage are disposed.

FIG. 5 is a partial, perspective view of the body frame on which the front storage is disposed.

FIG. 6 is a schematic perspective view of a front part of the body frame, for illustrating how first and second support parts support a steering shaft.

FIG. 7 is a drawing for illustrating the state in which a detachable frame is mounted to the support part of the body frame.

FIG. 8 is a drawing for showing the state in which batteries are arranged in a storage area.

FIG. 9 is a drawing for showing the state in which a battery and storage boxes are arranged in the storage area.

FIG. 10 is a schematic perspective view for showing the positional relation between a rear storage and a hitch receiver provided on a rear part of the body frame.

FIG. 11 is a schematic top view of the body frame, for illustrating first and second assemblies.

### DETAILED DESCRIPTION OF THE INVENTION

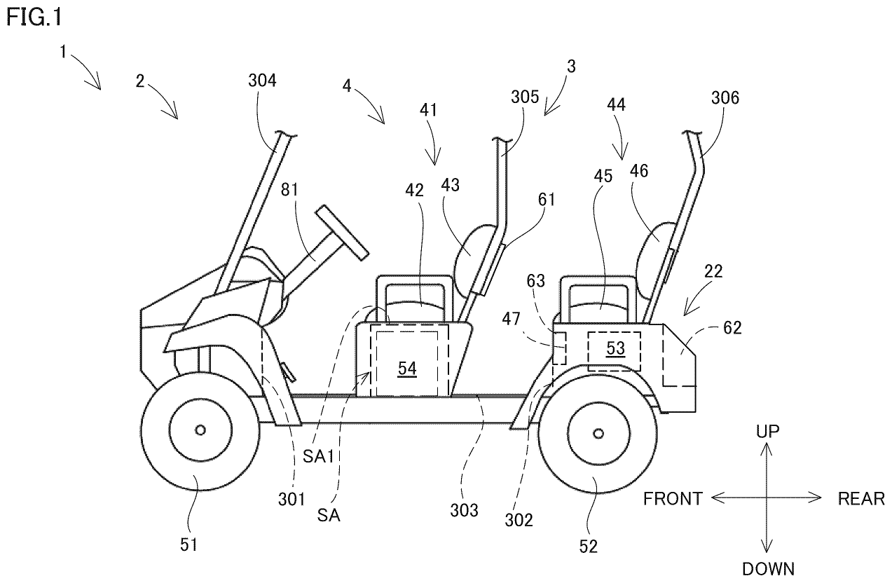

FIG. 1 is a schematic side view of a vehicle 1 according to one embodiment of the present disclosure. The vehicle 1 of this embodiment is designed to travel at low speed in a limited area. The limited area is, for example, a limited community area, private road or private property (such as a golf course and a park). The limited community area is an area available to local residents, such as an area including houses and public facilities (such as schools and hospitals). The low speed is, for example, a speed up to 20 to 30 mph. The vehicle 1 may travel at a speed below 20 mph or over 30 mph. The vehicle 1 includes a Personal Transport Vehicle (PTV) including a golf cart. The vehicle 1 may be a Low Speed Vehicle (LSV) or other golf carts.

In FIG. 1 and the following drawings, a front-rear direction, an up-down direction and a right-left direction of the vehicle 1 are appropriately shown. The front-rear direction is also a vehicle length direction. In the front-rear direction, a direction to the front is a forward travelling direction of the vehicle 1, and a direction to the rear is a backward travelling direction of the vehicle 1. The right-left direction is also a vehicle width direction. In the right-left direction, the left side and the right side refer to the left side and the right side of the vehicle 1 facing forward, respectively. In the up-down direction, the lower side refers to the side of the vehicle 1 on which wheels are arranged. In FIG. 1 and the following drawings, a roof is not shown.

The vehicle 1 includes a vehicle body 2 having a body frame 3, a pair of right and left front wheels 51, a pair of right and left rear wheels 52 and a power mechanism for travelling of the vehicle 1. In this embodiment, the power mechanism is a motor 53.

A cabin 4 in which a user gets in is provided between the front and rear wheels 51, 52 in the vehicle body 2. A front seat 41 is arranged in a front part of the cabin 4. The front seat 41 has a seat part 42 extending in the vehicle width direction and a backrest part 43 formed corresponding to the seat part 42. In this embodiment, the seat part 42 is a so-called bench seat and continuously extend substantially from the left end to the right end of the vehicle body 2 in the vehicle width direction.

The vehicle body 2 has a storage area SA having an opening SA1 just under the seat part 42. In this embodiment, a battery 54 is arranged in the storage area SA. The battery 54 supplies electric power to the motor 53 and electronic devices mounted on the vehicle 1. The storage area SA is described in detail below. The backrest part 43 has a pocket-like storage 61 formed, for example, by installing a net on a back surface of the backrest part 43.

A rear seat 44 is arranged in a rear part of the cabin 4. Like the front seat 41, the rear seat 44 has a seat part 45 continuously extending from the left end to the right end in the vehicle width direction and a backrest part 46 formed corresponding to the seat part 45. The rear seat 44 has a recessed part 47 formed by part of a rear panel 302 being recessed rearward in a front end lower part of the seat part 45. The recessed part 47 has a pocket-like storage 63 formed, for example, by attaching a net to the recessed part 47.

The motor 53 is arranged in a rear part 22 of the vehicle body 2. The motor 53 is arranged under the rear seat 44. A rear storage 62 is further provided in the rear part 22 of the vehicle body 2. In this embodiment, the rear storage 62 is open upward and rearward.

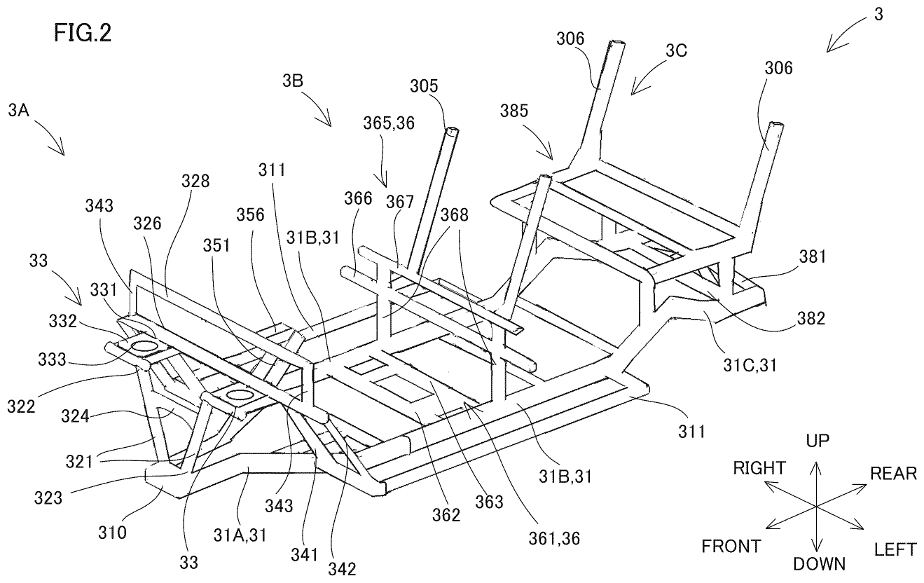

The body frame 3 is a frame structure formed of a sectioned material. The body frame 3 serves as a skeleton of the vehicle body 2. The body frame 3 realizes a rollover protective structure (ROPS). In FIG. 1, a front pillar 304, a center pillar 305 and a rear pillar 306 are shown as part of the body frame 3. In FIG. 2 and the following drawings, the front pillar 304 is not shown.

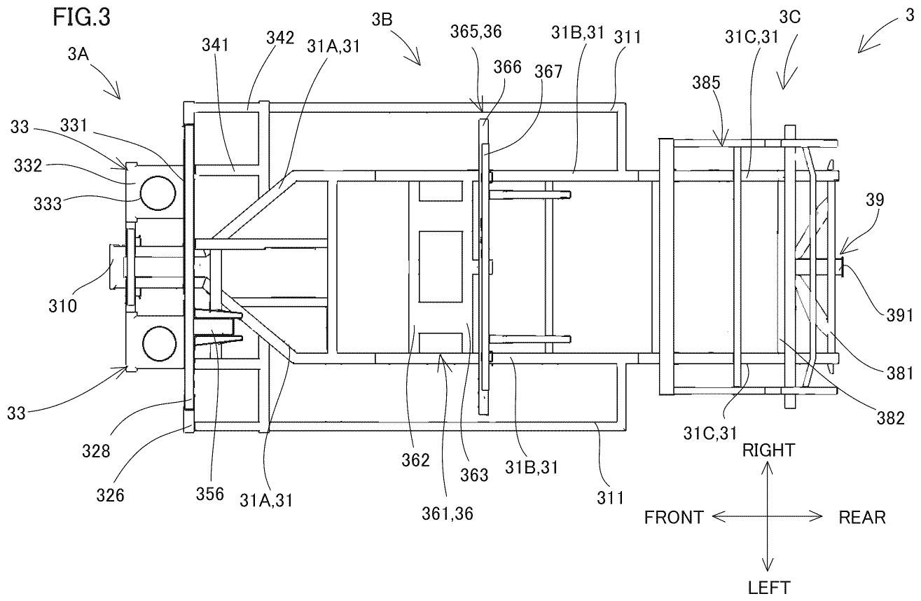

As shown in FIGS. 2 and 3, the body frame 3 includes a pair of side members 31 extending in the front-rear direction and frames. The frames include frames extending in the vehicle width direction, support frames that support component parts of the vehicle 1, and reinforcing frames that reinforce these frames. Among the frames, the frames bridged between the side members 31 and the frames bridged between the support frames are also referred to as cross members. Each of the frames may be formed of steel plate or aluminum alloy. The body frame 3 of this embodiment has a pair of outer side members 311 respectively provided on the outer sides of the side members 31 in the vehicle width direction. In other embodiments, the outer side members 311 may be omitted. In the present disclosure, the pair of side members 31 can also be referred to as the two side members 31, or the left side member 31 and the right side member 31. The same is true for other pair structures (parts) in the present disclosure.

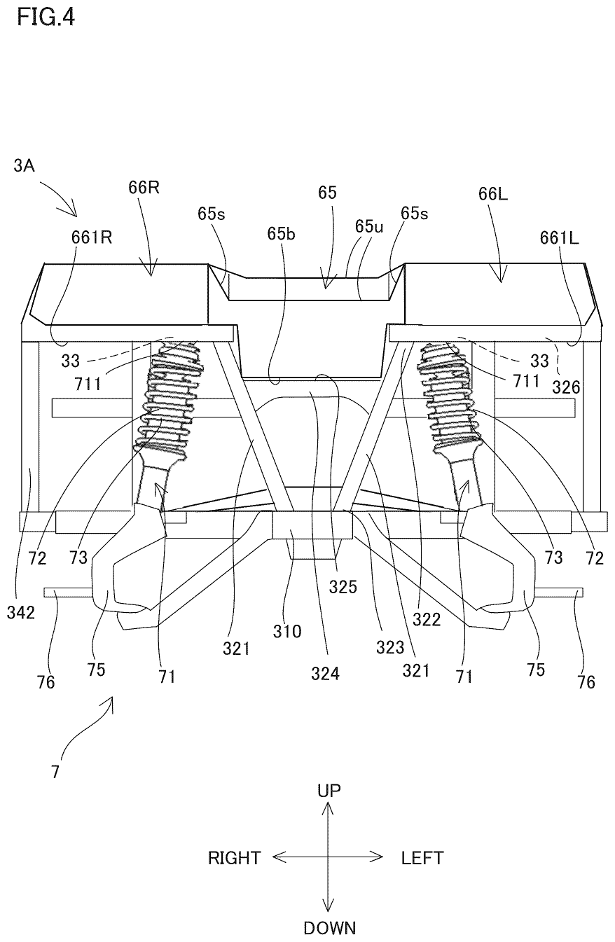

The body frame 3 has a front part 3A, a central part 3B and a rear part 3C in the front-rear direction. The front part 3A supports, for example, a front suspension 7 (FIG. 4) of the vehicle 1. The central part 3B supports, for example, the front seat 41 and the battery 54. The rear part 3C supports, for example, the rear seat 44, the motor 53 and a rear suspension.

The two side members 31 include respective floor side members 31B extending substantially parallel to each other in the front-rear direction in the central part 3B, respective front side members 31A in front of the floor side members 31B, and respective rear side members 31C behind the floor side members 31B. The left and right front side members 31A are connected at a front end part 310 of the body frame 3.

The front part 3A of the body frame 3 and component parts of the vehicle 1 that are supported by the front part 3A are now specifically described. The front part 3A mainly includes the pair of front side members 31A, a pair of front frames 321, a front cross member 324, a first frame 326, a second frame 328 and a pair of support frames 33.

The first frame 326 extends from the left end to the right end of the vehicle body 2 in an upper part of the front part 3A. A left end part of the first frame 326 in the vehicle width direction is connected to the left front side member 31A and the left outer side member 311 via left frames 341, 342. Similarly, a right end part of the first frame 326 is also connected to the right front side member 31A and the right outer side member 311 via right frames 341, 342. The second frame 328 extends over the whole vehicle width just above the first frame 326. An end of the second frame 328 in the vehicle width direction is connected to an end of the first frame 326 in the vehicle width direction via a frame 343. In this disclosure, to “connect” may also be said as to “fix” or to “join”.

The support frames 33 are connected to the first frame 326. The left and right support frames 33 are apart from each other in the vehicle width direction. Specifically, each of the support frames 33 has a rear end 331 connected to the first frame 326, and protrudes forward from the first frame 326. In this embodiment, the support frame 33 has a generally rectangular plate part 332 as viewed from above and an opening 333 formed through the plate part 332 in the up-down direction.

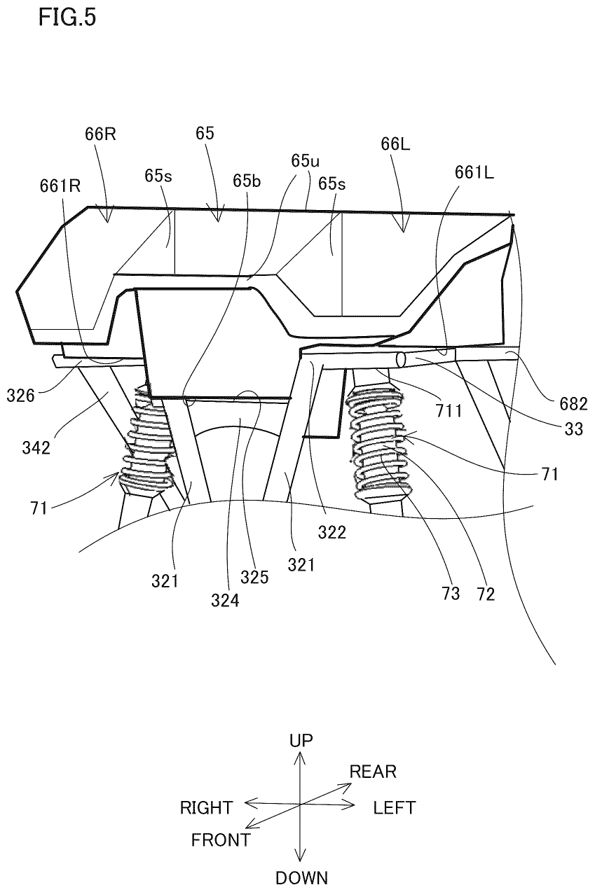

As shown in FIG. 4, a front suspension 7 connects the vehicle body 2 and the front wheels 51 and suppresses the transmission of vibrations caused by unevenness of a road surface to the vehicle body 2. The front suspension 7 includes a pair of shock absorbers 71, a pair of lower arms 75 and a pair of wheel support parts 76. Each of the shock absorbers 71 has an absorber 72 and a coil spring 73. The shock absorber 71 is also referred to as a damper. As shown in FIGS. 4 and 5, each of the support frames 33 supports an upper end 711 of the shock absorber 71. In this embodiment, the upper end 711 is inserted through the opening 333 and fixed to the plate part 332.

As shown in FIG. 4, each of the front frames 321 extends downward from the support frame 33. An upper end 322 of the front frame 321 is connected to the support frame 33, and a lower end 323 of the front frame 321 is connected to the front end part 310. The distance between the lower ends 323 of the front frames 321 is shorter than the distance between the upper ends 322 of the front frames 321. The front frames 321 are arranged to be inclined to reduce the distance from each other toward the front end part 310. The front cross member 324 is bridged between the front frames 321 below the support frames 33 and above the front end part 310. In this embodiment, the front cross member 324 is bridged between the front frames 321 at a position higher than a half of the height of the front frames 321 in the up-down direction. In other words, the front cross member 324 is bridged between the front frames 321 at a position closer to the upper ends 322 than to the lower ends 323.

The front part 3A is configured to support a front storage 65. As shown in FIGS. 4 and 5, the front storage 65 has a box-like shape and is arranged between the front frames 321. The front storage 65 has a bottom wall 65b, side walls 65s connected to left and right ends of the bottom wall 65b, and an upper wall 65u. The bottom wall 65b is located below the support frames 33. The bottom wall 65b is supported by an upper end 325 (upper surface) of the front cross member 324. The bottom wall 65b can also be referred to as a lower end, a lower part, a bottom part or a bottom surface of the front storage 65. The upper wall 65u is located above the support frames 33. In this embodiment, the upper wall 65u defines an upper opening of the front storage 65. The upper wall 65u can also be referred to as an upper end, an upper part or an upper surface of the front storage 65.

In this embodiment, parts storage parts 66L, 66R are provided on the left and right sides of the front storage 65. The parts storage parts 66L, 66R store, for example, parts of left and right head lights. The parts storage parts 66L, 66R are supported on upper surfaces of the support frames 33 (upper surfaces of the plate parts 332), respectively. The bottom wall 65b of the front storage 65 is located below bottom walls 661L, 661R of the parts storage parts 66L, 66R. In this embodiment, the parts storage parts 66L, 66R are integrally formed with the front storage 65. In other embodiments, the parts storage parts 66L, 66R may be separately formed from the front storage 65.

As described above, the pair of support frames 33 to which the upper ends 711 of the pair shock absorbers 71 are respectively fixed, and the pair front frames 321 extending downward from the support frames 33 are provided in the front part 3A of the body frame 3. The front cross member 324 is bridged between the front frames 321. Therefore, the bottom wall 65b of the front storage 65 can be arranged to protrude downward and supported by the front cross member 324. Thus, the storage area of the front storage 65 can be enlarged. As a result, the storage area can be enlarged, for example, without increasing the vehicle width or length of the vehicle 1.

Further, in this embodiment, the parts storage parts 66L, 66R are provided on the left and right sides of the front storage 65, and the bottom walls 661L, 661R of the parts storage parts 66L, 66R are supported by the support frames 33. Thus, at least one of weight reduction, manufacturing cost reduction and structural simplification of the body frame 3 can be achieved, compared with a structure in which a frame that supports the upper end 711 of the shock absorber 7 is separately formed from a frame that supports the bottom walls 661L, 661R of the parts storage parts 66L, 66R.

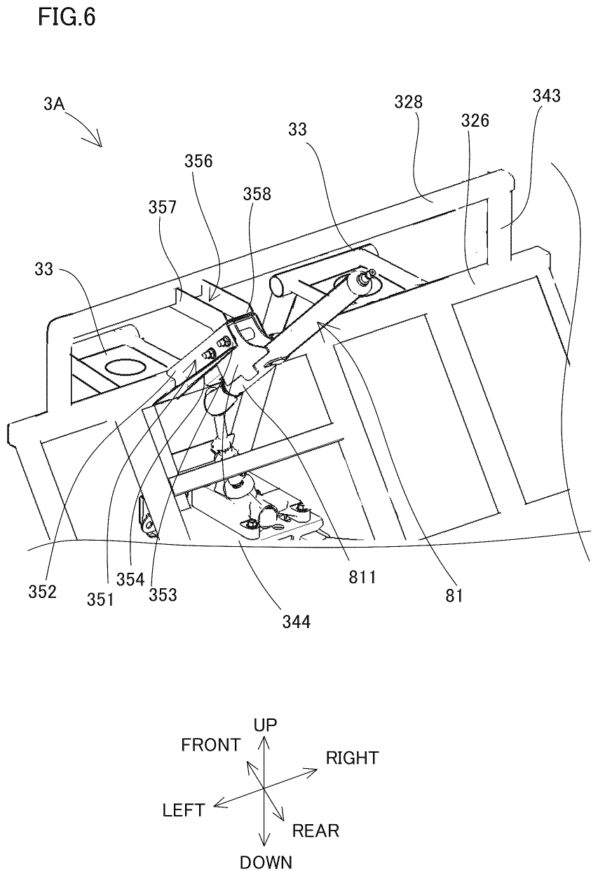

The front part 3A of the body frame 3 is configured to further support a steering shaft 81. As shown in FIG. 6, the front part 3A has a first support part 351 and a second support part 356 as a structure of supporting the steering shaft 81. The steering shaft 81 is provided on a driver's seat of the vehicle 1, which is on the left side in the vehicle width direction in this embodiment. The steering shaft 81 can also be referred to as a steering column.

The second support part 356 has a front end part 357 connected to the second frame 328 and extends rearward from the second frame 328. The extending direction of the second support part 356 is substantially orthogonal to the up-down direction and the left-right direction. The first support part 351 has a front end 352 connected to the first frame 326 and extends rearward and upward from the first frame 326. A rear end 353 of the first support part 351 is connected to a rear end 358 of the second support part 356. In this embodiment, the first and second support parts 351, 356 are located in front of a dash panel 301 that defines a front wall of the cabin 4. Therefore, the first and second support parts 351, 356 are not seen in FIG. 1.

The first support part 351 has a recessed part 354 that is open downward. The recessed part 354 is continuously formed in the extending direction of the first support part 351. The first support part 351 directly or indirectly supports the steering shaft 81 in the recessed part 354. The recessed part 354 serves as a holding part for holding the steering shaft 81. In this embodiment, the recessed part 354 covers a base part 811 of the steering shaft 81 from above and holds the steering shaft 81 in a suspended manner. The base part 811 may also be referred to as a lower end part of the steering shaft 81. In this embodiment, the first support part 351 indirectly holds the steering shaft 81 via a bracket 344 that is mounted to the recessed part 354 with a bolt. In other embodiments, the first support part 351 may be configured to directly support the steering shaft 81.

As described above, in the front part 3A, the body frame 3 has the first support part 351 that protrudes rearward and upward from the first frame 326, and the second support part 356 that protrudes rearward from the second frame 328. The rear end 358 of the second support part 356 is connected to the rear end 353 of the first support part 351. The first support part 351 is configured to hold the steering shaft 81. Therefore, load on the steering shaft 81 is dispersed to the first and second frames 326, 328 via the first and second support parts 351, 356. Therefore, deflection and distortion of the steering shaft 81 are suppressed even if the steering shaft 81 is relatively long.

One example of suppressing deflection and distortion of the steering shaft 81 may include a structure of holding the steering shaft 81 by one frame via one support member formed of a high strength material. Use of a high strength material may however increase the manufacturing costs. In this embodiment, load on the steering shaft 81 is dispersed by utilizing the first and second support parts 351, 356, so that the manufacturing costs can be reduced compared with a structure specially using a high strength material.

In this embodiment, the first and second support parts 351, 356 are arranged forward of a dash panel 301, so that the structure for supporting the steering shaft 81 is not exposed to the cabin 4. Therefore, the design of the vehicle 1 can be improved while deflection and distortion of the steering shaft 81 are suppressed.

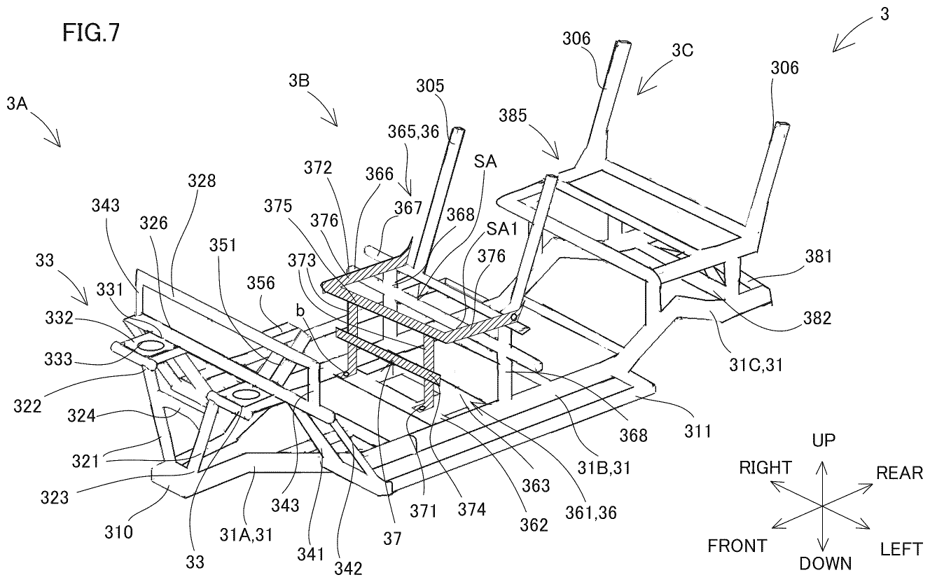

As shown in FIG. 2, a support part 36 is provided in the central part 3B of the body frame 3. As shown in FIG. 7, the body frame 3 of this embodiment is configured such the storage area SA is defined just under the seat part 42 by a detachable frame 37 being mounted to the support part 36. The support part 36 is configured to support parts stored in the storage area SA.

The support part 36 includes a lower support part 361 and a rear support part 365. The lower support part 361 has a first support cross member 362 and a second support cross member 363 that are bridged between the floor side members 31B. The second support cross member 363 is located just behind the first support cross member 362. The lower support part 361 is located just below the seat part 42 in the front-rear direction.

The rear support part 365 has a pair of frames 368 extending in the up-down direction, and third and fourth frames 366, 367 extending in the vehicle width direction. The frames 368 protrude upward from the floor side members 31B, in the vicinity of the lower support part 361, or more specifically in the vicinity of a rear end of the second support cross member 363. The third frame 366 is connected to the frames 368. The fourth frame 367 is connected to the frames 368 above the third frame 366. The third and fourth frames 366, 367 of the rear support part 365 are located behind the seat part 42.

In FIG. 7, the detachable frame 37 mounted to the body frame 3 is shown hatched. The detachable frame 37 has a lower end part 371 that is connected to the support part 36, and an upper end part 372 that directly or indirectly supports the seat part 42. In this embodiment, the detachable frame 37 has a pair of first detachable frames 373 that are connected to the first support cross member 362 at the lower end part 371 and extend in the up-down direction, a second detachable frame 374 and a third detachable frame 375 that extend in the vehicle width direction, and a pair of fourth detachable frames 376 that extend rearward from the third detachable frame 375.

The first detachable frames 373 are connected to the first support cross member 362 at the lower end part 371 and extend in the up-down direction. The second and third detachable frames 374, 375 are connected to the first detachable frames 373 and extend in the vehicle width direction. The third detachable frame 375 is connected to upper ends of the first detachable frames 373 above the second detachable frame 374. The fourth detachable frames 376 extend rearward from left and right ends of the third detachable frame 375, respectively. Rear ends of the fourth detachable frames 376 are connected to the fourth frame 367.

As shown in FIG. 7, the support part 36 and the detachable frame 37 define the storage area SA by mounting the detachable frame 37 to the support part 36. On the top of the storage area SA, the upper end part 372 of the detachable frame 37 and an upper end part of the fourth frame 367 of the rear support part 365 define the opening SA1. In this embodiment, the detachable frame 37 is connected to the support part 36 with bolts b. The detachable frame 37 may be connected to the support part 36 with removable connecting means other than the bolts b.

At least one part can be disposed in the storage area SA. The parts include the battery 54 and a storage box 69. When a part is disposed in the storage area SA, for example, the part is placed on the lower support part 361 and thereafter the detachable frame 37 is disposed surrounding the part. The part may be connected to part of the detachable frame 37 with a bolt b. Thereafter, the detachable frame 37 is connected to the support part 36 with the bolts b. The seat part 42 is arranged on the top of the detachable frame 37.

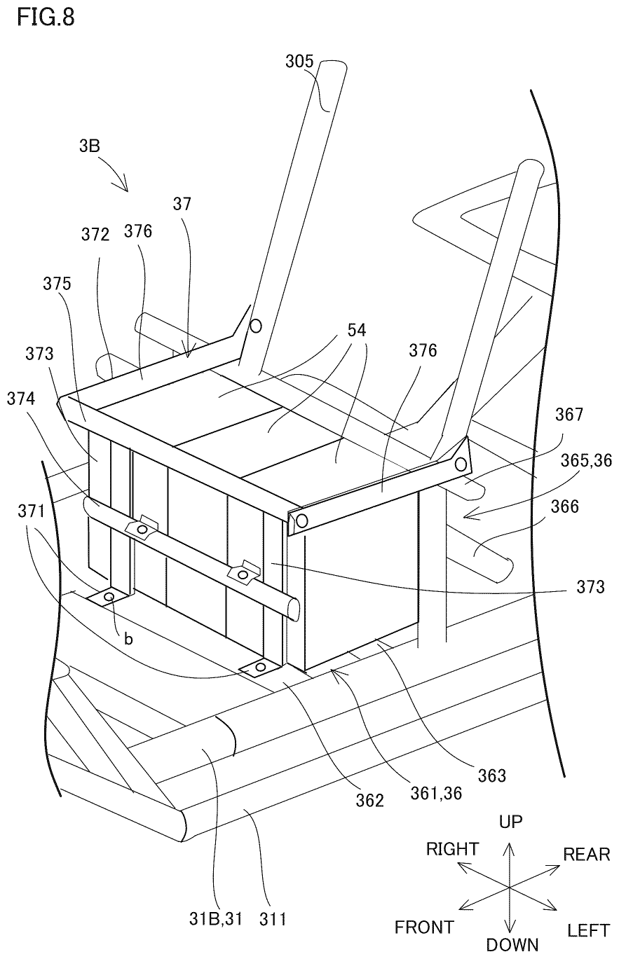

In FIG. 8, three batteries 54 are shown as an example of the at least one part disposed in the storage area SA. In this embodiment, the three batteries 54 have the same specifications. Thus, the batteries 54 have the same external shape. The length of each battery 54 in the front-rear direction is substantially equal to the length of the seat part 42 in the front-rear direction. The number of the batteries 54 disposed in the storage area SA can be appropriately changed according to the specifications of the vehicle 1.

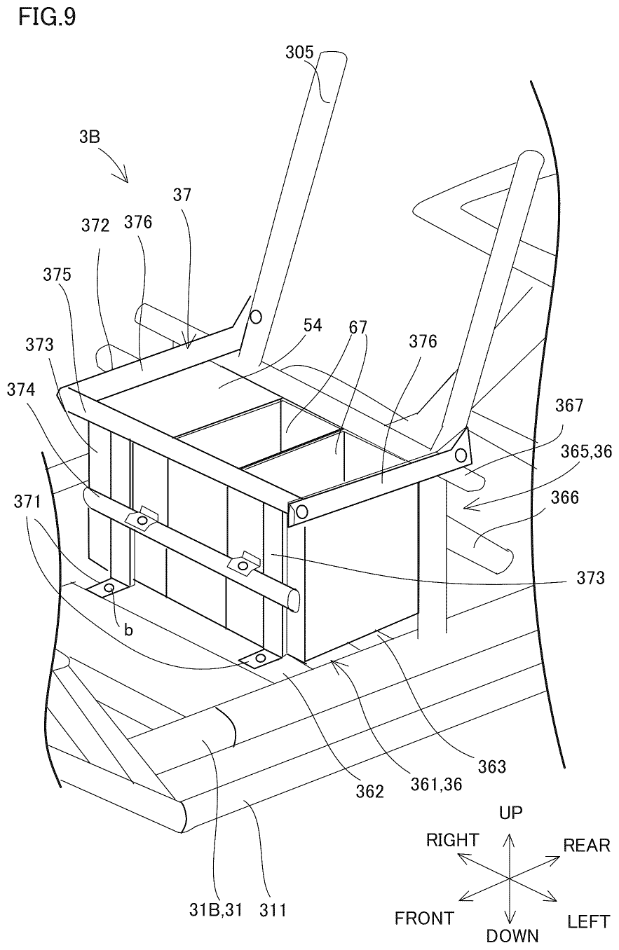

In FIG. 9, one battery 54 and two storage boxes 69 are shown as an example of the at least one part disposed in the storage area SA. In this embodiment, the outer dimensions or the lengths of each storage box 69 in the front-rear direction and the vehicle width direction are substantially equal to the outer dimensions of the battery 54. In FIG. 9, the battery 54 is disposed on the right end in the vehicle width direction. In this embodiment, the driver's seat is a left seat on the front seat 41, and the battery 54 is disposed on the side opposite to the driver's seat in the vehicle width direction.

As described above, the body frame 3 has the support part 36, which includes the floor side members 31B and the first and second support cross members 362, 363 bridged between the floor side members 31B, and the detachable frame 37 that is removably connected to the support part 36 just below the seat part 42. Thus, the support part 36 and the detachable frame 37 define the storage area SA just below the seat part 42, and at least one part can be disposed in the storage area SA. Therefore, an area for storing parts can be secured without increasing the vehicle width or length of the vehicle 1.

The battery 54 and the storage box 69 disposed in the storage area SA have substantially the same external shape, which increases increasing the freedom of arrangement for the battery 54 and storage box 69 within the storage area SA.

Further, by forming the seat part 42 to be openable and closable in the up-down direction, a user can reach the storage area SA through the opening SA1 with a hand. This also facilitates maintenance of the parts disposed in the storage area SA.

In the vehicle 1 of this embodiment, the battery 54 is disposed on the side opposite to the driver's seat in the vehicle width direction when the battery 54 and the storage box 69 are disposed in the storage area SA or when only one battery 54 is disposed in the storage area SA. With this arrangement, the weight balance in use of the vehicle 1 is improved.

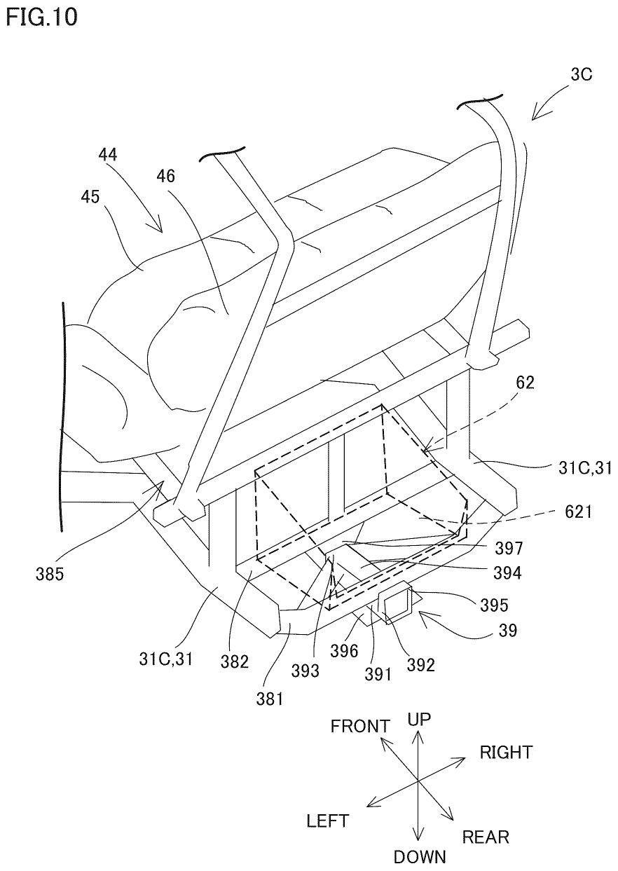

As shown in FIG. 10, the rear part 3C of the body frame 3 mainly includes the pair of rear side members 31C, first and second rear cross members 381, 382 bridged between the rear side members 31C, and a hitch receiver 39. The first rear cross member 381 is bridged between rear ends of the rear side members 31C. The second rear cross member 382 is bridged between the rear side members 31C in front of the first rear cross member 381. A rear seat support frame 385 is provided in front of the second rear cross member 382 and configured to support the rear seat 44.

The hitch receiver 39 is provided behind and below the rear seat support frame 385. The hitch receiver 39 has a body 391 and brackets 396, 397. The body 391 is connected to central parts of the first and second rear cross members 381, 382 in the vehicle width direction and extends in the front-rear direction. A receiver opening 395 is formed in a rear end 392 of the body 391. The body 391 has a rectangular cylindrical shape. The body 391 is configured such that a front end part of an object to be towed can be inserted from the receiver opening 395 of the rear end 392 and connected to the body 391. The bracket 396 connects the rear end 392 of the body 391 to the first rear cross member 381. The bracket 397 connects a front end 393 of the body 391 to the second rear cross member 382.

In FIG. 10, a rear storage 62 of the vehicle 1 is shown by a broken line. A bottom part 621 of the rear storage 62 is supported on an upper end 394 of the hitch receiver 39.

As described above, the body frame 3 has the hitch receiver 39 in the rear part 3C. The body 391 of the hitch receiver 39 extends in the front-rear direction in a rear lower part of the body frame 3. The bottom part 621 of the rear storage 62 is supported on the upper end 394 of the body 391 of the hitch receiver 39. Thus, the hitch receiver 39 is provided with a function of supporting the rear storage 62 in addition to the function as a receiver. Therefore, a storage area can be secured in the vehicle 1 by effectively utilizing an area above the hitch receiver 39. Further, at least one of weight reduction, manufacturing cost reduction and structural simplification of the body frame 3 can be achieved, compared with a structure in which the hitch receiver 39 is separately formed from a frame for supporting the rear storage 62.

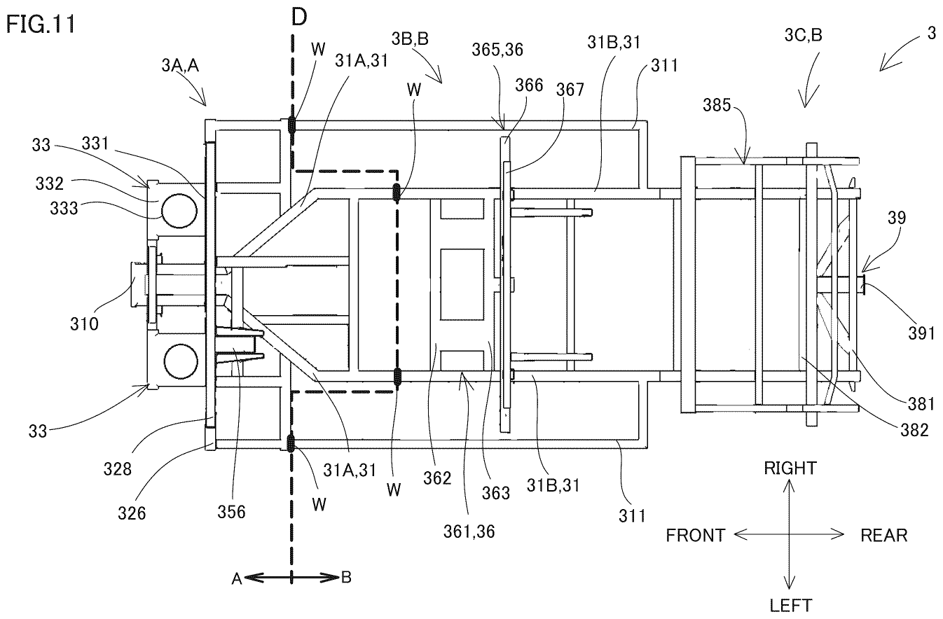

Next, a manufacturing example of the body frame 3 is described. As shown in FIG. 11, the body frame 3 of this embodiment as a whole is manufactured by separately preparing a first assembly A and a second assembly B and thereafter connecting the first and second assemblies A, B. In FIG. 11, a boundary between the first and second assemblies A, B is shown by a broken line D. The first assembly A is a front part and the second assembly B is a rear part, relative to the broken line D. The first assembly A forms the front part 3A of the body frame 3. The whole of the first assembly A is located forward of the front seat 41, or forward of the first support cross member 362 of the support part 36. The second assembly B forms the central part 3B and the rear part 3C of the body frame 3 in the front-rear direction. At least part of the second assembly B is located forward of the front seat 41, or forward of the first support cross member 362 of the support part 36.

The body frame 3 is manufactured by connecting a rear end of the first assembly A and a front end of the second assembly B. The first and second assemblies A, B are connected, for example, by welding. In this embodiment, the first and second assemblies A, B are connected at four connections W shown in FIG. 11. As described above, the second assembly B forms a part of the body frame 3 located rearward of the support part 36 that supports the front seat 41. Therefore, when manufacturing vehicles having different specifications, the first assembly A can be used in common to the vehicles, and the structure of the second assembly B can be changed according to the specifications of the vehicles such as the presence or absence of the rear seat 44. Thus, the costs for manufacturing the vehicles having different specifications can be reduced. Examples of the vehicles having different specifications include vehicles not having at least one of the support part 36, the hitch receiver 39 and the rear seat support frame 385, and vehicles using liquid fuel such as gasoline or gas fuel such as hydrogen gas as a power source of a power mechanism. The second assembly B may be appropriately prepared according to these specifications.

Correspondences between the component elements (features) of the above-described embodiment and the component elements (features) of the present disclosure are as follows. However, the component elements of the above-described embodiment are merely exemplary and do not limit the component elements of the present disclosure.

The vehicle 1 is an example of the “vehicle”.

The shock absorber 71 is an example of the “shock absorber”. The upper end 711 is an example of the “upper end of the shock absorber”.

The pair of support frames 33 is an example of the “pair of support frames”.

The rear end 331 is an example of the “rear end of the support frame”.

The pair of front frames 321 is an example of the “pair of front frames”.

The front cross member 324 is an example of the “front cross member”.

The front storage 54 is an example of the “storage”.

The bottom wall 65b and the upper wall 65u are examples of the “bottom surface” and the “upper surface”, respectively.

The first frame 326 and the second frame 328 are examples of the “first frame” and the “second frame”, respectively.

The first support part 351, the front end 352 and the rear end 353 are examples of the “first support part”, the “first front end part” and the “first rear end part”, respectively.

The second support part 356, the front end part 357 and the rear end 358 are examples of the “second support part”, the “second front end part” and the “second rear end part”, respectively.

The recessed part 354 is an example of the “recessed part” and the “holding part”. The dash panel 301 is an example of the “dash panel”.

The front seat 41 and the seat part 42 are examples of the “front seat” and the “seat part”, respectively.

The pair of floor side members 31B and the pair of side members 31 are examples of the “pair of side members”.

The first support cross member 362, the second support cross member 363, the lower support part 361, the rear support part 365 and the support part 36 are examples of the “support part”.

The first support cross member 362 and the second support cross member 363 are examples of the “support cross member”.

The detachable frame 37 and the lower end part 371 are examples of the “detachable frame” and the “lower end part”, respectively.

The storage area SA and the opening SA1 are examples of the “storage area” and the “opening”, respectively.

The battery 54 and the storage box 69 are examples of the “battery” and the “storage box”, respectively.

The hitch receiver 39 and the body 391 are examples of the “hitch receiver”.

The upper end 394 is an example of the “upper end of the hitch receiver”.

The rear storage 62 and the bottom part 621 are examples of the “rear storage” and the “bottom part of the rear storage”, respectively.

The pair of rear side members 31C is an example of the “pair of rear side members”.

The body frame 3 is an example of the “body frame”.

The first assembly A and the second assembly B are examples of the “first assembly” and the “second assembly”, respectively.

The above-described embodiment is merely exemplary, and a vehicle according to the present disclosure is not limited to the vehicle 1 of the above-described embodiment. For example, the following non-limiting modifications may be made.

The power mechanism of the vehicle is not limited to the motor 53, but may be an engine. In the vehicle having an engine, a fuel tank may be disposed on the side opposite to the driver's seat in the vehicle width direction. Further, in the vehicle having an engine, the battery 54 need not be disposed in the storage area SA, and the storage boxes 69 may be disposed in the storage area SA.

The length of the storage box 69 in the vehicle width direction may be different from the length of the battery 54 in the vehicle width direction.

The vehicle need not have the rear seat 44. The vehicle may have a third row seat in the rear part 3C. The front seat 41 of the vehicle is not limited to a bench seat, but may be two seats separated from each other to the left and right.

The support frames 33 may just be connected to a frame extending in the vehicle width direction, and may be connected to the second frame 328, or to a frame other than the first and second frames 326, 328.

The number of the frames of the detachable frame 37 and the mounting position of the detachable frame 37 on the support part 36 may be different from those of the first embodiment, provided that the detachable frame 37 is removably mounted on the support part 36 and the opening SA1 is defined on the top of the detachable frame 37.

The seat part 42 of the bench seat need not be disposed on the top of the detachable frame 37. Two seat parts of two seats separated from each other to the left and right, or other parts forming the vehicle may be disposed on the top of the detachable frame 37.

The present disclosure is not limited to the above-described embodiment, but rather, may be embodied in various other aspects without departing from the spirit and scope of the present disclosure. For example, the present disclosure can also be embodied in the following aspects. The technical features of the above-described embodiments corresponding to the technical features of the following aspects can be appropriately replaced or combined with each other in order to realize part or the whole of the object of the present disclosure or to realize part or all of the effects of the present disclosure. Further, the technical features can be appropriately deleted unless described as essential in the specification of the present disclosure.

1. A vehicle, comprising:
a pair of support frames that are arranged apart from each other in the vehicle width direction and to which upper ends of left and right shock absorbers disposed on a front wheel side of the vehicle are respectively fixed;
a pair of front frames that extend downward from the support frames, respectively; and
a front cross member that is bridged between the front frames.

2. The vehicle as defined in claim 1, wherein the front cross member is bridged between the front frames at a position higher than a half of the height of the front frames in an up-down direction.

3. The vehicle as defined in claim 1, wherein:
a storage is provided between the support frames,
an upper surface of the storage is located above the support frames, and
a bottom surface of the storage is located on the front cross member.

4. The vehicle as defined in claim 3, wherein the front cross member supports the bottom surface.

5. The vehicle as defined in claim 1, comprising:
a first frame that extends in the vehicle width direction;
a second frame that extends in the vehicle width direction above the first frame;
a first support part that protrudes rearward and upward from the first frame, and has a first front end part that is connected to the first frame, and a first rear end part on a side opposite to the first front end part in an extending direction; and
a second support part that protrudes rearward from the second frame, and has a second front end part that is connected to the second frame, and a second rear end part that is connected to the first rear end part,
wherein the first support part has a holding part that holds a steering shaft.

6. The vehicle as defined in claim 5, wherein the holding part comprises a recessed part that is open downward in the first support part.

7. The vehicle as defined in claim 5, wherein the holding part holds a base part of the steering shaft.

8. The vehicle as defined in claim 5, wherein the first and second support parts are arranged forward of a dash panel of the vehicle.

9. The vehicle as defined in claim 5, wherein rear ends of the support frames are connected to the first frame.

10. The vehicle as defined in claim 1, comprising:
a front seat that has a seat part extending in the vehicle width direction;
a support part that includes a pair of side members extending in a front-rear direction, and a support cross member bridged between the side members under the front seat; and
a detachable frame that is removably mounted on the support part, and has a lower end part that is connected to the support part and an upper end part that is configured to support the seat part, the detachable frame being configured to define a storage area that has an opening under the seat part when mounted on the support part.

11. The vehicle as defined in claim 10, wherein a battery is disposed in the storage area.

12. The vehicle as defined in claim 11, wherein:
a storage box is disposed in the storage area; and
a length of the storage box in the vehicle width direction is substantially equal to the length of the battery in the vehicle width direction.

13. The vehicle as defined in claim 1, comprising:
a hitch receiver extending in the front-rear direction in a rear part of the vehicle; and
a rear storage having a bottom part that is supported by an upper end part of the hitch receiver.

14. The vehicle as defined in claim 1, comprising:
a body frame that includes the pair of support frames, the pair of front frames and the front cross member; and
a front seat;
wherein the body frame includes a first assembly located forward of the front seat, and a second assembly, at least part of which is located forward of the front seat and which is disposed behind the first assembly, in the front-rear direction.

15. A vehicle, comprising:
a first frame that extends in the vehicle width direction;
a second frame that extends in the vehicle width direction above the first frame;
a first support part that protrudes rearward and upward from the first frame, and has a first front end part that is connected to the first frame, and a first rear end part on a side opposite to the first front end part in an extending direction; and
a second support part that protrudes rearward from the second frame, and has a second front end part that is connected to the second frame, and a second rear end part that is connected to the first rear end part,
wherein the first support part has a holding part that holds a steering shaft.

16. The vehicle as defined in claim 15, wherein the holding part comprises a recessed part that is open downward in the first support part.

17. A vehicle, comprising:
a front seat having a seat part that extends in the vehicle width direction;
a support part that includes a pair of side members extending in a front-rear direction of the vehicle, and a support cross member bridged between the side members under the front seat; and
a detachable frame that is removably mounted on the support part and has a lower end part that is connected to the support part and an upper end part that is configured to support the seat part, the detachable frame being configured to define a storage area that has an opening under the seat part when mounted on the support part.

18. The vehicle as defined in claim 17, wherein a battery is disposed in the storage area.

19. The vehicle as defined in claim 18, wherein:
a storage box is disposed in the storage area; and
a length of the storage box in the vehicle width direction is substantially equal to the length of the battery in the vehicle width direction.

20. A vehicle, comprising:
a hitch receiver extending in the front-rear direction in a rear part of the vehicle; and
a rear storage having a bottom part that is supported by an upper end part of the hitch receiver.
